(19) United States
(12) Patent Application Publication
(10) Pub. No.: US 2017/0109850 A1
(43) Pub. Date: Apr. 20, 2017

(54) SYSTEM AND METHOD FOR RECOMMENDING OPPORTUNITIES FOR CAREER PROGRESSION

(71) Applicant: International Business Machines Corporation, Armonk, NY (US)

(72) Inventors: Malolan Chetlur, Bangalore (IN); Vinay Kumar Reddy, Bangalore (IN); Bikram Sengupta, Bangalore (IN)

(21) Appl. No.: 14/883,535

(22) Filed: Oct. 14, 2015

(51) Int. Cl. G06Q 50/20

(52) U.S. Cl. CPC G06Q 50/2057

(57) ABSTRACT

Methods and arrangements for recommending career progression events involving receiving career path goal information for a user, accessing data sources comprising information associated with at least one career progression event a user is eligible to attend; extracting at least one career progression event from said user data sources; scoring said at least one extracted career progression event based upon a comparison of said at least one career progression event to said received career path goal information; and providing said user a notification of said at least one extracted career progression event having a score exceeding a predetermined threshold. Other variants and embodiments are broadly contemplated herein.

### BACKGROUND

Many business organizations offer a wide array of daily activities that their employees can participate in and attend. Such activities include seminars, talks, hackathons, idea jams, stretch projects, etc. These activities can provide employees with a number of valuable benefits that can help them progress further in their careers. However, most employees do not actively attend these events because they do not believe that they contain any substantial value. This may cause employees to miss out on important information and networking opportunities related to their career path. The ability to know which of these daily activities are the most relevant to career progression can help employees reach their desired career goals more quickly.

### BRIEF SUMMARY

In summary, one aspect of the invention provides a method of recommending career progression events, said method comprising: utilizing at least one processor to execute computer code that performs the steps of: receiving career path goal information for a user; accessing data sources comprising information associated with at least one career progression event a user is eligible to attend; extracting at least one career progression event from said user data sources; scoring said at least one extracted career progression event based upon a comparison of said at least one career progression event to said received career path goal information; and providing said user a notification of said at least one extracted career progression event having a score exceeding a predetermined threshold.

Another aspect of the invention provides an apparatus for recommending career progression events, said apparatus comprising: at least one processor; a computer readable storage medium having computer readable program code embodied therewith and executable by the at least one processor, the computer readable program code comprising: computer readable program code that receives career path goal information for a user; computer readable program code that accesses data sources comprising information associated with at least one career progression event a user is eligible to attend; computer readable program code that extracts at least one career progression event from the user data sources; computer readable program code that scores the at least one extracted career progression event based upon a comparison of the at least one career progression event to the received career path goal information; and computer readable program code that provides the user notification of the at least one extracted career progression event having a score exceeding a predetermined threshold.

An additional aspect of the invention provides a computer program product for recommending career progression events, said computer program product comprising: a computer readable storage medium having computer readable program code embodied therewith, the computer readable program code comprising: computer readable program code that receives career path goal information for a user; computer readable program code that accesses data sources comprising information associated with at least one career progression event a user is eligible to attend; computer readable program code that extracts at least one career progression event from the user data sources; computer readable program code that scores the at least one extracted career progression event based upon a comparison of the at least one career progression event to the received career path goal information; and computer readable program code that provides the user notification of the at least one extracted career progression event having a score exceeding a predetermined threshold.

A further aspect of the invention provides a method of recommending career progression events, said method comprising: utilizing at least one processor to execute computer code that performs the steps of: receiving career path goal information for a user; accessing data sources comprising information associated with at least one career progression event a user is eligible to attend; extracting at least one career progression event from said user data sources, wherein said at least one extracted career progression event is enriched with meta-data comprising at least one member selected from the group consisting of name of event, type of event, skill acquired, skill level, duration, and category; scoring said at least one extracted career progression event based upon a comparison of said at least one career progression event to said received career path goal information; providing said user a notification of said at least one extracted career progression event having a score exceeding a predetermined threshold; and determining, based upon said scored at least one extracted career progression event, a career progression plan for career progression and displaying said career progression plan to said user.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates an exemplary embodiment of a career progression adviser.

FIG. 2 schematically illustrates the steps involved within the activity extractor portion.

FIG. 3 schematically illustrates the steps involved within the opportunity aligner portion.

FIG. 4 schematically illustrates the steps involved within the career progression adviser portion.

FIG. 5 illustrates an example embodiment comprising an event invitation with opportunity aligner scores attached.

FIG. 6 sets forth a process more generally for recommending career progression.

FIG. 7 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

Many large business organizations provide opportunities for their employees to attend a number of career progression events such as hackathons, stretch projects, executive assignments/studies, talks, technical meetings, idea jams, seminars, etc. These intrinsic, day to day activities are useful for an employee's career development. They can provide employees with useful information, additional training, exposure to new concepts, and networking opportunities. Unfortunately, most employees do not actively participate in these events because they do not believe that these events can provide them with any meaningful career benefits.

By not realizing the potential career benefits associated with these daily events, employees may be hindering their career progression. Currently, existing career guidance solutions recommend attending training sessions and participating in new activities. However, these solutions incur additional costs for training and re-skilling. What is missing from the existing solutions is the ability to incorporate intrinsic, career progression events into a career guidance plan. If a solution existed that could recommend specific events that an employee should attend based on the employee's activity preferences and career goals then they may be able to progress toward their career goals more quickly.

Accordingly, an embodiment provides a method of mining a user's (herein referred to as “employee” for ease of understanding) data sources (e.g., emails, calendar, logs, social media, etc.) and extracting any upcoming career progression events. Then, the extracted events are scored based on relevance, effectiveness and influence and mapped to an employee's specific career path goals. Therefore, events that are determined to share a high degree of similarity with a given career path are recommended. Then, based on an employee's personal preferences, an optimum plan is created that dynamically organizes and schedules the upcoming events to promote quicker career progression. The aforementioned process will be discussed in detail in the following paragraphs.

The description now turns to the figures. The illustrated embodiments of the invention will be best understood by reference to the figures. The following description is intended only by way of example and simply illustrates certain selected exemplary embodiments of the invention as claimed herein.

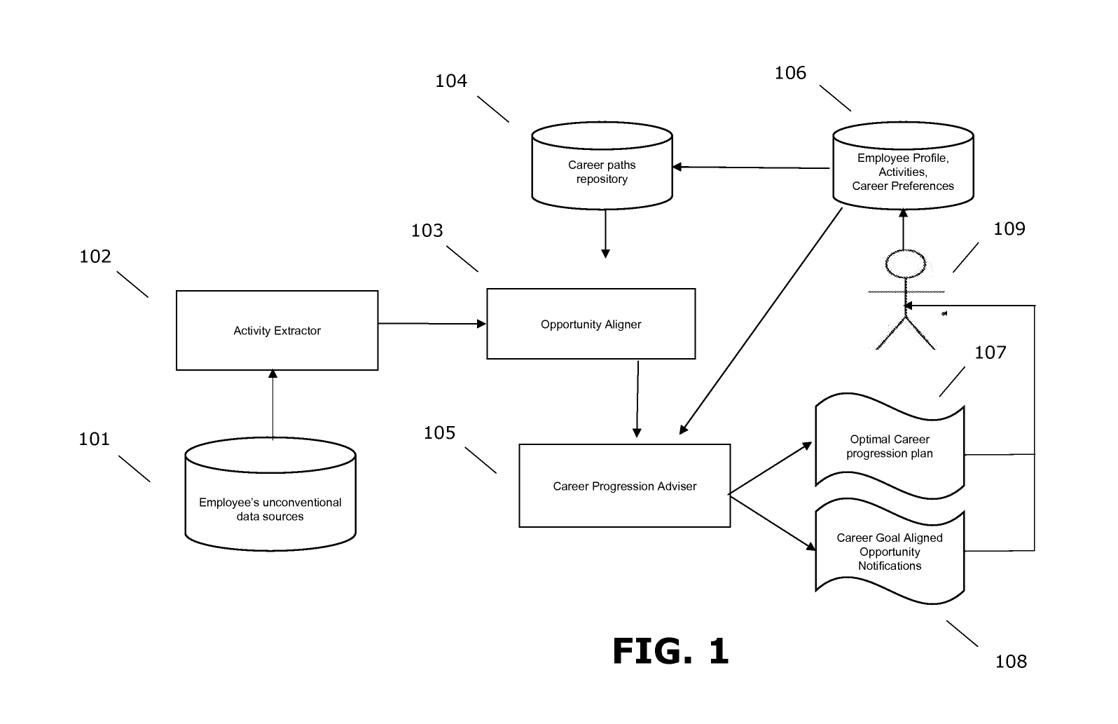

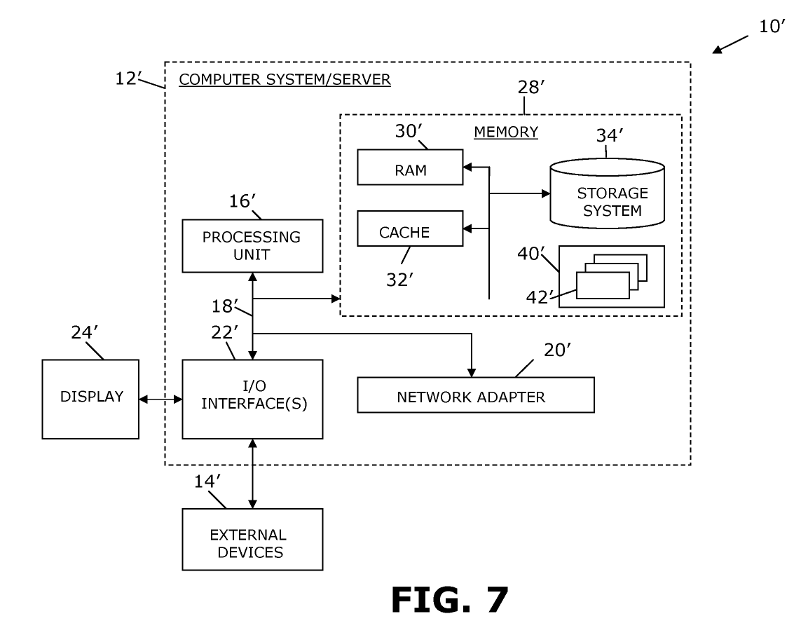

Specific reference will now be made here below to the figures. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 7. In accordance with an exemplary embodiment, most if not all of the process steps, components and outputs discussed with respect to FIG. 1 can be performed or utilized by way of a processing unit or units and system memory such as those indicated, respectively, at 16′ and 28′ in FIG. 7, whether on a server computer, a client computer, a node computer in a distributed network, or any combination thereof.

As shown in FIG. 1, an embodiment may glean an employee's data sources 101 for career progression events. The identified career progression events are then extracted by using an activity extractor 102. Then, an opportunity aligner 103 takes the extracted events and classifies and maps them to various career paths and career path roles stored in a career path repository 104. From here, a career progression adviser 105 personalizes a plan based on an employee's profile and personal preferences 106 and produces an optimal career progression plan 107 and also notifies the employee about high value opportunities that are aligned with their stated career goals 108. The career progression adviser can dynamically update the plan based on an employee's explicit and implicit feedback 109.

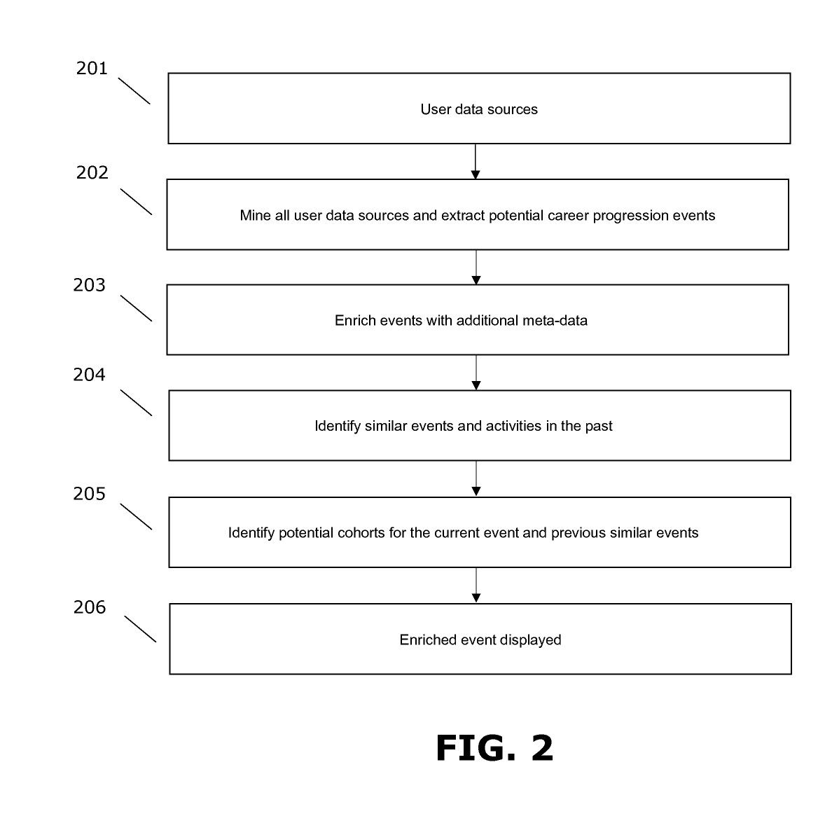

Referring now to FIG. 2, an embodiment utilizes an activity extractor that mines all of an employee's user data sources 201 and extracts potential career progression events 202. User data sources 201 include emails, calendars, calls for participation, wikis, weblogs, and other relevant sources that record employee activities. Career progression events include hackathons, stretch projects, executive assignments/studies, talks, technical meetings, idea jams, seminars and any other event that may benefit an employee in furthering their career.

In a further embodiment, an event dictionary is created that stores all of the mined career progression events. Keyword extraction techniques are used on event descriptions to identify basic event details (e.g., type of event, event duration, etc.). Once the data sources 201 are mined 202, they are enriched with meta-data 203. Heuristics are used to identify additional meta-data. As an example, the “from-to” section of an event description maps to the duration of an event. As a further example, follow up descriptions after verbs like “learn,” “code,” and “improve” map to the skills that can be learned from the event.

In an additional embodiment, based on identified attributes in a given event description, previously held events that share common attributes to the given event are identified 204. Then, based upon the common attributes of the people who previously participated in these past events (e.g., job title when attended, job title currently, skill level, etc.), the activity extractor identifies the category that the current event belongs to 205. The attributes of the people who attended past events can be stored in an organization's HR database. For example, an employee who wants to become a cloud developer is invited to attend event X. If a number of people who were previously in the employee's position attended event X and are now cloud developers, the current event may be placed in the category of events associated with the cloud developer career path. The enriched events 206 may then be displayed with all the appropriate meta-data attached (e.g., Event A <name, type, skill acquired, skill level, duration, hands-on, category, group activity, instructor-led, instructor-name, recognition, category, similar-events>).

In an additional embodiment, in addition to events and opportunities determined from user data sources 201, the system can extract data sources 202 from external call-for-activities, announcements and conventional career progression related training

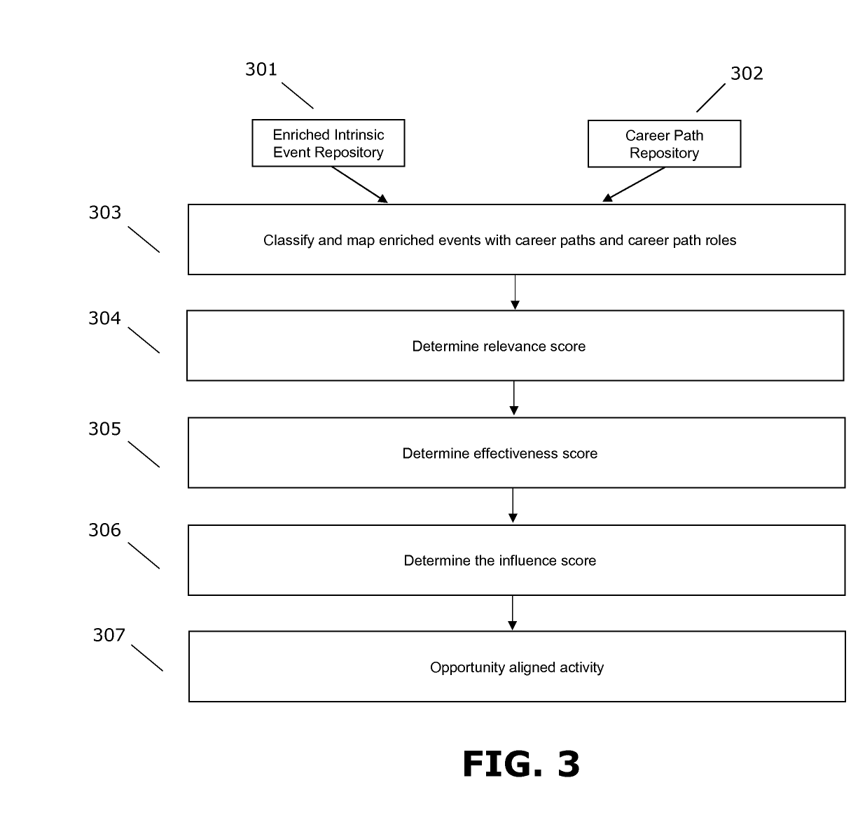

Referring now to FIG. 3, an embodiment may utilize an opportunity planner to classify and map 303 the enriched career progression events 301 to potential career paths and roles that are stored in a career path repository 302. Based on the similarity between descriptions of career paths (and roles within a career path) and the event descriptions, events are mapped to similar career paths. The career path repository 302 contains the descriptions of the career paths and can be located on a system the employee's organization maintains. For example, an event, such as a “BlueMix” hackathon, is related to the cloud computing career path and specifically to roles like cloud architect and cloud developer because it shares similar attributes to those careers.

In a further embodiment, a relevance score 304 is determined between a career progression event and a career path goal. It is plausible that an event may map to more than one career path role. What is required is some kind of ranking system. So from the meta-data that are extracted from a particular event, the role, business level, and skill level of the people who have actually attended similar past events can be inferred. With this information, a ranking system can be constructed based on relevance of the activity toward the employee's desired career goal. For example, for an employee who wishes to become a cloud developer, the relevance score of event A is higher than the relevance score of event B because the attributes of the people who have attended event A align more with the cloud developer career path than the attributes of the people who have attended event B, which align more with the mobile computing career path. Records of previous events attended by other employees are typically stored in an organization's HR database, which can be accessed.

In an additional embodiment, an effectiveness score 305 is determined between a career progression event and a career path goal. Given a number of career paths that an event can be matched to, an effectiveness score can be determined based on how quickly people who have attended that event in the past have progressed towards the employee's desired career goal. For example, for an employee who wants to become a cloud developer, event A is more effective when compared to event B because previous employees who have attended event A became cloud developers much more quickly than those who have attended event B. The rates of career progression of employees are typically stored in an organization's HR database, which can be accessed.

In an additional embodiment, an influence score 306 is determined between a career progression event and a career path goal based on the networking opportunities associated with the particular event. The influence score of an event is based on a combination of two primary factors: 1) The event's reach and 2) the volume of people attending the event. An event's reach refers to the corporate status of the people who attend the event (e.g., an event with great reach would be attended by many executives). With respect to the volume factor, an event that is attended by a high volume of people would have a greater influence score because there would be more people available to network with. The aforementioned information can be inferred by the profiles of the people that have attended the event or from the people that will be attending the event. This information can be stored in an organization's HR database.

In an additional embodiment, all three of the aforementioned scores (i.e. relevance, effectiveness, and influence) can be used to map a career progression event to a career path to produce an opportunity aligned activity 307. Furthermore, any one of the three scores used individually or in combination can produce an opportunity aligned activity 307.

In an additional embodiment, a minimum score for each scoring category (i.e., relevance, effectiveness, influence) can be set. In order for a career progression event to qualify as an opportunity aligned activity, it must meet or exceed this predetermined threshold score. The predetermined threshold can be set by the user or can be automatically gleaned from the system.

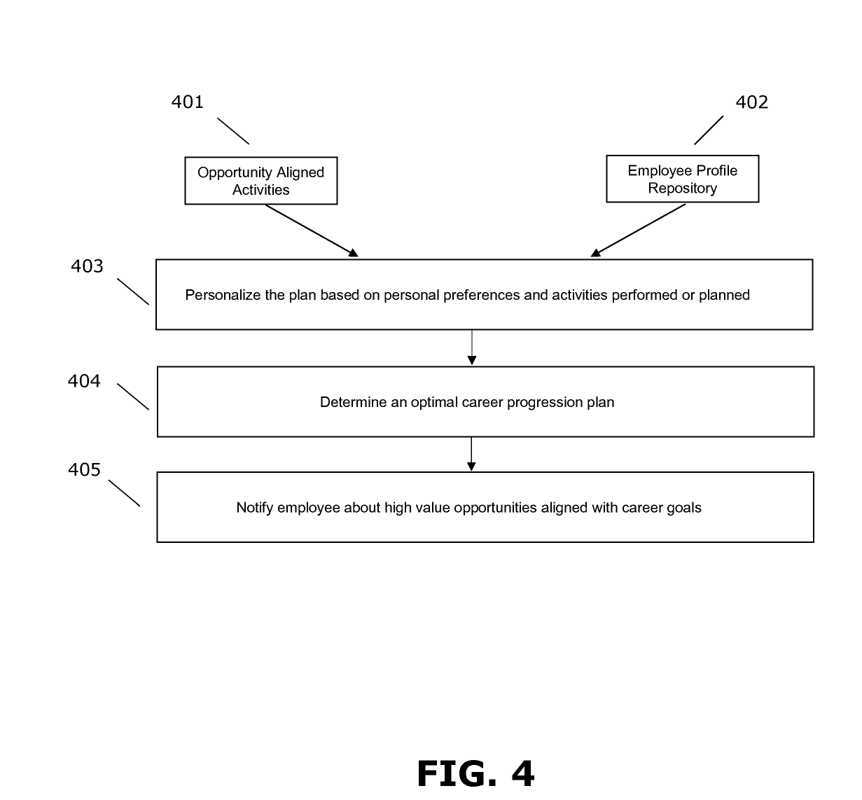

Referring now to FIG. 4, an embodiment utilizes a career progression adviser to personalize a plan based on the available opportunity aligned activities 401 and employee preferences located in an employee profile repository 402. The employee profile repository may contain, among other things, the title and description of the employee's current job. At 403, an employee is queried about their career path goals and personal activity preferences and can insert this information into an interface. Examples of user insertable information can include career path goal information, such as the desired career goal the employee would like to eventually achieve, and the specifics of the events they would like to attend, such as the time of an event, the length of an event, the type of event, the number of people that can attend the event, etc. Alternatively, at 403, a user's career path goals and activity preferences can be gleaned automatically based on the user's attendance of past events. A log of past events attended by a user can be stored in an organization's HR database, which can be accessed.

In a further embodiment, an optimal career progression plan is determined 404 based on the employee's current role, skills, time constraints and the combined or individual scores of various opportunity aligned activities 401. The scored opportunity aligned activities 401 are compared to the employee preferences to determine which of the opportunity aligned activities best satisfies the employee's personal preferences. Opportunity aligned activities 401 with varying levels of importance to the user are selected based on the user preferences to multiple career path roles. The selected events are prioritized based on the relevance that they share with the various career path roles of interest to the user. The time duration of the events is determined and the time availability of the user is gleaned from the user's calendars. A particular career progression plan is provided to the user based on the optimization of various identified parameters. The plan can also be optimized based on a user's attendance of past events.

In an additional embodiment, the career progression adviser dynamically updates the career progression plan as new events are added to the system. Therefore, it can notify the employee about new opportunities aligned with their desired career path 406. Furthermore, the plan can change if a newly announced event is determined to be more useful to an employee than a previously scheduled event. If two events are scheduled at the same time, the career progression adviser can recommend one event over another based on the user's time commitments and the totality of the event scores.

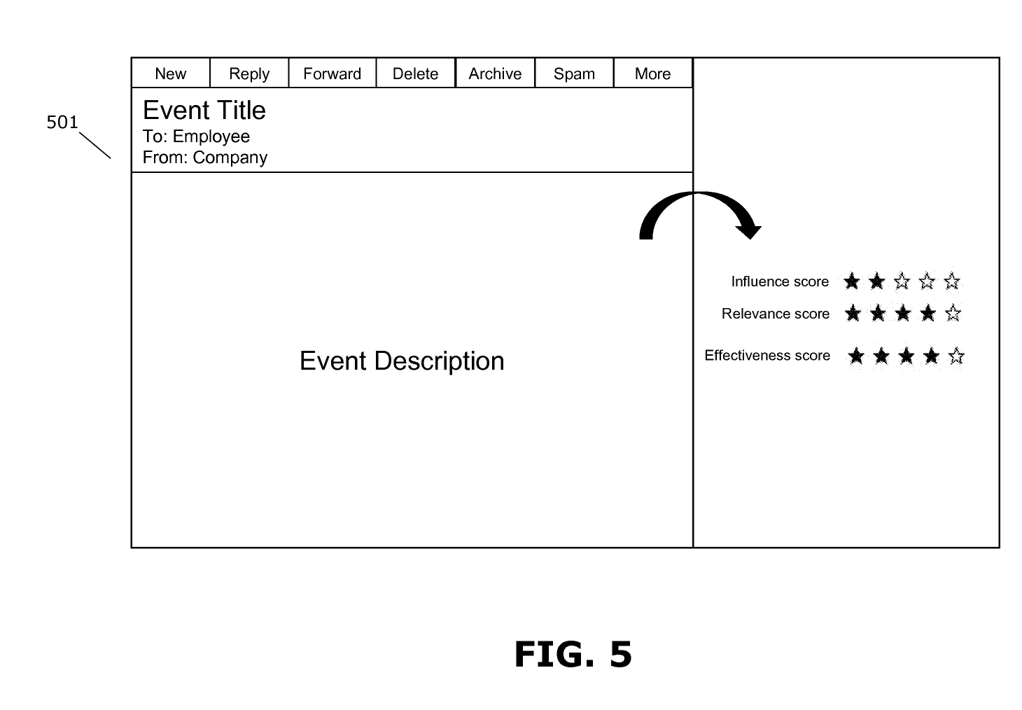

Referring now to FIG. 5, an embodiment may visually present the scores associated with a career progression event to a user. For example, in 501 when a user receives an email to attend an event, not only will the user see the event invite, but they will also see the three scores that will let them know how important the event will be to their career progression. In addition, an event can be sent out in a regular email but with a customized display. In an additional embodiment, a user can be notified by other means such as through calendar updates, social media notifications, text messages, phone calls, and through various other notification means.

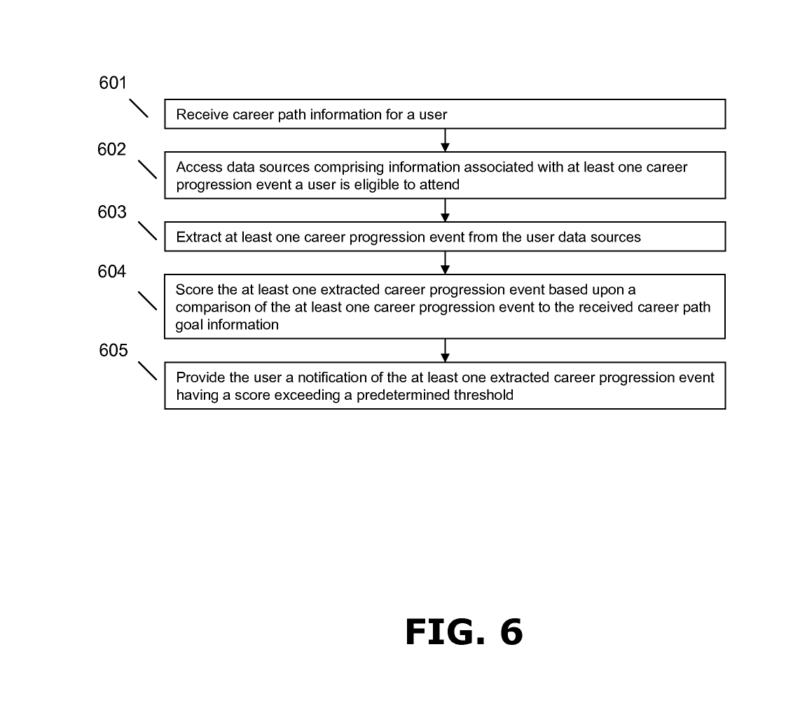

Referring now to FIG. 6, an embodiment receives career path information for a user 601. An embodiment then accesses data sources comprising information associated with at least one career progression event a user is eligible to attend 602. An embodiment then extracts at least one career progression event from the user data sources 603. An embodiment then scores the at least one extracted career progression event based upon a comparison of the at least one career progression event to the received career path goal information 604. An embodiment then provides the user a notification of the at least one extracted career progression event having a score exceeding a predetermined threshold 605.

Referring now to FIG. 7, a schematic of an example of a computing node is shown. Computing node 10′ is only one example of a suitable computing node and is not intended to suggest any limitation as to the scope of use or functionality of embodiments of the invention described herein. Regardless, computing node 10′ is capable of being implemented and/or performing any of the functionality set forth hereinabove. In accordance with embodiments of the invention, computing node 10′ may be part of a cloud network or could be part of another type of distributed or other network (e.g., it could represent an enterprise server), or could represent a stand-alone node.

In computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of recommending career progression events, said method comprising:
utilizing at least one processor to execute computer code that performs the steps of:
receiving career path goal information for a user;
accessing data sources comprising information associated with at least one career progression event a user is eligible to attend;
extracting at least one career progression event from said user data sources;
scoring said at least one extracted career progression event based upon a comparison of said at least one career progression event to said received career path goal information; and
providing said user a notification of said at least one extracted career progression event having a score exceeding a predetermined threshold.

2. The method according to claim 1, comprising building an event dictionary for said at least one extracted career progression event.

3. The method according to claim 1, wherein said at least one extracted career progression event is enriched with meta-data comprising at least one member selected from the group consisting of name of event, type of event, skill acquired, skill level, duration, and category.

4. The method according to claim 1, wherein said scoring comprises assigning, to said at least one extracted career progression event, at least one score selected from the group consisting of a relevance score, an effectiveness score, and an influence score.

5. The method according to claim 1, comprising comparing said scored at least one extracted career progression event to user career progression event preferences.

6. The method according to claim 1, wherein said providing comprises notifying said user by at least one notification selected from the group consisting of emails, calendar updates, social media notifications, text messages, and phone calls.

7. The method according to claim 1, comprising determining, based upon said scored at least one extracted career progression event, a career progression plan for career progression and displaying said career progression plan to said user.

8. The method according to claim 7, comprising updating said career progression plan based on extraction of at least one additional career progression event.

9. The method according to claim 1, comprising identifying at least one similar past career progression event based on an event description of a current career progression event.

10. The method according to claim 1, comprising determining a category associated with said at least one extracted career progression event based upon stored attributes of attendees of at least one similar past career progression event.

11. An apparatus for recommending career progression events, said apparatus comprising:
at least one processor;
a computer readable storage medium having computer readable program code embodied therewith and executable by the at least one processor, the computer readable program code comprising:
computer readable program code that receives career path goal information for a user;
computer readable program code that accesses data sources comprising information associated with at least one career progression event a user is eligible to attend;
computer readable program code that extracts at least one career progression event from the user data sources;
computer readable program code that scores the at least one extracted career progression event based upon a comparison of the at least one career progression event to the received career path goal information; and
computer readable program code that provides the user notification of the at least one extracted career progression event having a score exceeding a predetermined threshold.

12. A computer program product for recommending career progression events, said computer program product comprising:
a computer readable storage medium having computer readable program code embodied therewith, the computer readable program code comprising:
computer readable program code that receives career path goal information for a user;
computer readable program code that accesses data sources comprising information associated with at least one career progression event a user is eligible to attend;
computer readable program code that extracts at least one career progression event from the user data sources;
computer readable program code that scores the at least one extracted career progression event based upon a comparison of the at least one career progression event to the received career path goal information; and
computer readable program code that provides the user notification of the at least one extracted career progression event having a score exceeding a predetermined threshold.

13. The computer readable program product according to claim 12, wherein the computer readable program code comprises:
computer readable program code that builds an event dictionary for said at least one extracted career progression event.

14. The computer readable program product according to claim 12, wherein the at least one extracted career progression event is enriched with meta-data comprising at least one member selected from the group consisting of name of event, type of event, skill acquired, skill level, duration, and category.

15. The computer readable program product according to claim 12, wherein the scoring comprises assigning, to the at least one extracted career progression event, at least one score selected from the group consisting of a relevance score, an effectiveness score, and an influence score.

16. The computer readable program product according to claim 12, wherein the providing comprises notifying the user by at least one notification selected from the group consisting of emails, calendar updates, social media notifications, text messages, and phone calls.

17. The computer readable program product according to claim 12, wherein the computer readable program code comprises:
computer readable program code that determines, based upon the scored at least one extracted career progression event, a career progression plan for career progression and displaying the career progression plan to the user.

18. The computer readable program product according to claim 17, wherein the computer readable program code comprises:
computer readable program code that updates the career progression plan based on extraction of at least one additional career progression event.

19. The computer readable program product according to claim 12, wherein the computer readable program code comprises:
computer readable program code that identifies at least one similar past career progression event based on an event description of a current career progression event.

20. A method of recommending career progression events, said method comprising:
utilizing at least one processor to execute computer code that performs the steps of:
receiving career path goal information for a user;
accessing data sources comprising information associated with at least one career progression event a user is eligible to attend;
extracting at least one career progression event from said user data sources, wherein said at least one extracted career progression event is enriched with meta-data comprising at least one member selected from the group consisting of name of event, type of event, skill acquired, skill level, duration, and category;
scoring said at least one extracted career progression event based upon a comparison of said at least one career progression event to said received career path goal information;
providing said user a notification of said at least one extracted career progression event having a score exceeding a predetermined threshold; and
determining, based upon said scored at least one extracted career progression event, a career progression plan for career progression and displaying said career progression plan to said user.
